(19) United States
(12) Patent Application Publication
(10) Pub. No.: US 2005/0012460 A1
(43) Pub. Date: Jan. 20, 2005

(54) Noise dampening degaussing coil holder

(75) Inventors: Brian Joosung Kim, San Diego, CA (US); Jared Lee Zamaloff, San Diego, CA (US)

Correspondence Address: ROGITZ & ASSOCIATES, Suite 3120, 750 B Street, San Diego, CA, 92101, US

(73) Assignee: Sony Corporation Sony Electronics Inc.

(21) Appl. No.: 10/869,632

(22) Filed: Jun. 15, 2004

Related U.S. Application Data
(60) Provisional application No. 60/488,519, filed on Jul. 17, 2003.

(51) Int. Cl. H01J 29/06

(52) U.S. Cl. 315/8; 315/399

(57) ABSTRACT

A resilient cylindrical degaussing coil holder with longitudinal ribs closely surrounds a degaussing coil for a cathode ray tube (CRT) to dampen mechanical noise transmission from the coil to the chassis assembly that holds the CRT.

### RELATED APPLICATIONS

This application claims priority from U.S. provisional application Ser. No. 60/488,519, filed Jul. 17, 2003.

### I. FIELD OF THE INVENTION

The present invention relates generally to degaussing coils for cathode ray tubes.

### II. BACKGROUND OF THE INVENTION

Cathode ray tubes (CRTs) in general rely upon either electromagnetic or electrostatic deflection to scan an electron beam across a phosphor screen. Upon impact by electrons, the phosphors within the screen emit visible light in one or more colors. Large screen CRTs used in direct view television sets rely upon electromagnetic deflection generated by a yoke that is affixed to the neck of the CRT near the junction of the neck and the funnel of the CRT envelope.

Because certain components within the CRT, such as an inner magnetic shield, an aperture grill and a frame for the aperture grille, may become magnetized because of (1) magnetic fields generated by the yoke, or (2) other components within a television set such as permanent magnet loudspeakers, or (3) external accessories mounted on top of or near the television, such as video cassette recorders and video games, it is extremely desirable to periodically degauss the CRT in order to minimize distortion of an image created by scanning an electron beam across the phosphor screen of the CRT. In addition, heat shrink bands may also become magnetized.

Accordingly, degaussing coils have been provided within the CRT chassis to operate in accordance with principles known in the art to remove unwanted magnetization from the CRTs. As recognized herein, however, while effective for their intended purpose, degaussing coils can generate mechanical noise that can be transmitted to the chassis holding the CRT and/or to the CRT itself, which is distracting to users. Having made this critical observation, the solutions herein have been provided.

### SUMMARY OF THE INVENTION

A system includes a cathode ray tube (CRT) and at least one degaussing coil juxtaposed with the CRT. A resilient cylindrical degaussing coil holder closely surrounds the degaussing coil to dampen noise transmission from the coil to structure adjacent the coil.

The non-limiting holder may be formed with plural longitudinal ribs or with plural radial rings. The holder may be disposed on a heat shrink (HS) band that is positioned on the CRT, or on a support structure that is part of a chassis assembly. The holder can consist of a unitary piece of material. The CRT can establish part of a television.

In another aspect, a television includes a chassis assembly and at least one degaussing coil inside the chassis assembly. The TV also includes a noise dampening coil holder circumscribing the coil.

In yet another aspect, a display system includes magnetic degaussing means and chassis means holding the degaussing means. Mechanical noise dampening means closely surround the degaussing means for dampening the transmission to the chassis means of mechanical noise generated by the degaussing means.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a front view of a cathode ray tube (CRT) system embodied as a television, showing the CRT, portions of the chassis assembly, and two degaussing coils surrounded by the holders of the present invention, with the heat shrink (HS) band shown in cross-section;

FIG. 2 is a perspective view of one embodiment of the present degaussing coil holder, with portions broken away; and

FIG. 3 is a perspective view of another embodiment of the present degaussing coil holder.

### DETAILED DESCRIPTION OF THE PREFERRED EMBODIMENT

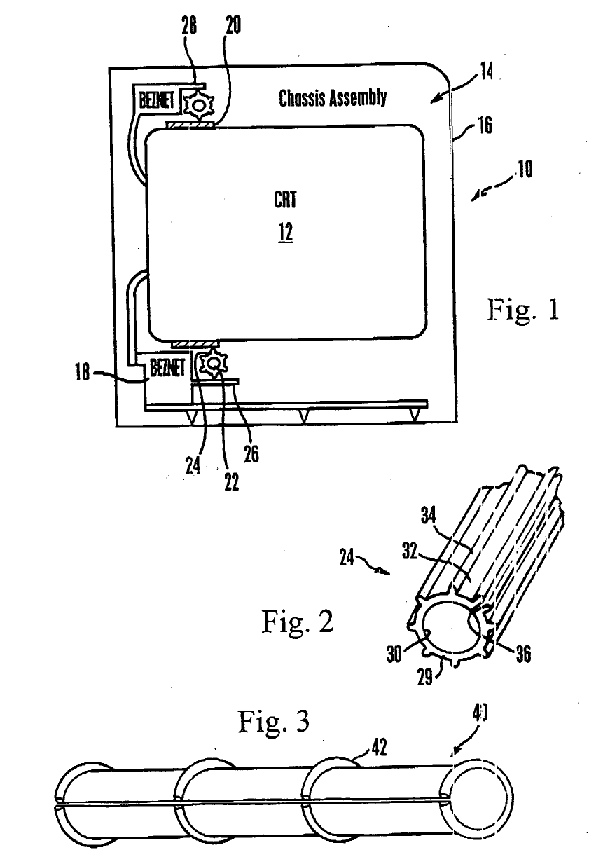

Referring initially to FIG. 1, a cathode ray tube (CRT) system embodied for illustration as a television system is shown, generally designated 10, that includes a CRT 12 or equivalent display and a chassis assembly 14. The chassis assembly 14 may include an outer housing 16 and structure interior to the housing 16, such as a halogen free, flame retardant support structure 18 colloquially known as “beznet”. Additionally, the system 10 may include one or more heat shrink (HS) steel anti-explosion bands 20 (only a single HS band 20 shown) that are wrapped around at least a portion of the CRT 12.

As shown in FIG. 1, one or more degaussing coils 22 are juxtaposed with the CRT 12. In the embodiment shown, two degaussing coils 22 are provided, although more could be provided if desired. The degaussing coils function in accordance with degaussing principles known in the art to degauss the system 10.

FIG. 1 shows that each coil 22 is closely received (e.g., in a tight fit) in a respective coil holder 24 of the present invention. The non-limiting coil holder 24 is resilient and may be made of plastic foam or rubber, and it circumscribes its respective coil 22 to substantially enclose the coil 22. In the embodiment shown in FIG. 1, the lower holder 24 with coil 22 rests on a lower boss 26 of the support structure 18, and is slightly below and spaced from the HS band 20. In contrast, the upper holder 24 with coil 22 rests on the HS band 20, slightly below and spaced from an upper boss 28 of the support structure 18. With this combination of structure, noise transmission from the coils 22 to structure adjacent the coils 22 is dampened by the holders 24. In some embodiments either holder 24 may be sandwiched between upper and lower structures in contact with both, with the resilience and configuration of the holder impeding the transmission of mechanical noise from the coil 22 to other structure outside the holder 24.

Now referring to FIG. 2, in one implementation the coil holder 24 has a generally cylindrical hollow body 29 defining a substantially cylindrical inner wall 30 and a substantially cylindrical outer wall 32. Plural longitudinally-oriented compressible ribs 34 can be integrally formed on the outer wall 32, and the ribs 34 can extend the length of the body 29 and rise radially outwardly from the outer wall 32 of the body 29. Thus, the holder 24 shown in FIG. 2 may be made of a unitary piece of material. Eight ribs are shown but greater or fewer ribs can be provided. When positioned inside the chassis assembly 14, one or more of the ribs 34 contact support structure and may slightly compress or deform.

As shown in FIG. 2, a longitudinal slit 36 can extend the length of the body 29. The slit 36 may be established for purposes of extruding the body 29 during manufacture and/or for facilitating the removal of the body 29 from an injection mold and/or to facilitate disposing the holder 24 around a degaussing coil. The embodiment shown in FIG. 2 may be made of plastic foam or rubber, and it may be made by extrusion or by injection molding.

FIG. 3 shows a degaussing coil holder generally designated 40 that can be in all essential respects identical in configuration and operation to the holder 24 shown in FIG. 2, with the following exceptions. The coil holder 40 shown in FIG. 3 may be made of rubber using injection molding techniques, or it may be extruded, and it may be made of foam. Instead of longitudinal ribs, the holder 40 shown in FIG. 3 can have plural radial rings 42 that are staggered along the length of the holder 40 and that rise radially outwardly beyond the outer cylindrical surface of the body of the holder 40 as shown.

While the particular NOISE DAMPENING DEGAUSSING COIL HOLDER as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims. For instance, the coil holder need not be made of a unitary piece of material unless otherwise claimed as such. In the claims, reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

1. A system, comprising:
at least one cathode ray tube (CRT);
at least one degaussing coil juxtaposed with the CRT; and
at least one resilient cylindrical degaussing coil holder closely surrounding the degaussing coil to dampen noise transmission from the coil to structure adjacent the coil.

2. The system of claim 1, wherein the holder is formed with plural longitudinal ribs.

3. The system of claim 1, wherein the holder is formed with plural radial rings.

4. The system of claim 1, wherein the holder is disposed on one of: a heat shrink (HS) band that is positioned on the CRT, or a support structure that is part of a chassis assembly.

5. The system of claim 1, wherein the holder consists of a unitary piece of material.

6. The system of claim 1, comprising plural degaussing coils and respective cylindrical holders.

7. The system of claim 1, wherein the CRT establishes part of a television.

8. A television, comprising:
at least one chassis assembly;
at least one degaussing coil inside the chassis assembly; and
at least one noise dampening coil holder circumscribing at least a portion of the coil.

9. The TV of claim 8, wherein the coil holder is generally cylindrical.

10. The TV of claim 9, wherein the coil holder is resilient.

11. The TV of claim 9, wherein the coil holder is formed with at least one longitudinal rib extending lengthwise along the outer surface of the holder.

12. The TV of claim 9, wherein the coil holder defines a cylindrical body and is formed with at least one raised ring circumscribing the body.

13. The TV of claim 8, further comprising a CRT inside the chassis assembly.

14. The TV of claim 9, wherein the coil holder is disposed on one of: a heat shrink (HS) band that is positioned on a CRT, or a support structure that is part of the chassis assembly.

15. A display system, comprising:
magnetic degaussing means;
chassis means holding the degaussing means; and
mechanical noise dampening means tightly receiving and surrounding the degaussing means for dampening the transmission to the chassis means of mechanical noise generated by the degaussing means.

16. The system of claim 15, further comprising display means within the chassis means.

17. The system of claim 15, wherein the mechanical noise dampening means includes at least one generally cylindrical resilient coil holder, the degaussing means being closely received in the holder.

18. The system of claim 17, wherein the coil holder is formed with at least one longitudinal rib extending lengthwise along the outer surface of the holder.

19. The system of claim 17, wherein the coil holder defines a cylindrical body and is formed with at least one raised ring circumscribing the body.
